(19) United States
(12) Patent Application Publication
(10) Pub. No.: US 2012/0221177 A1
(43) Pub. Date: Aug. 30, 2012

(54) METHOD OF CONTROLLING NAVIGATION OF ROBOT USING ELECTROMYOGRAPHY SENSOR AND ACCELERATION SENSOR AND APPARATUS THEREFOR

(75) Inventors: Hyun Chool SHIN, Seoul (KR); Ki Won RHEE, Seoul (KR); Kyung Jin YOU, Seoul (KR); Hee Su KANG, Seoul (KR)

(73) Assignee: Foundation of Soongsil University-Industry Cooperation, Seoul (KR)

(21) Appl. No.: 13/292,296

(22) Filed: Nov. 9, 2011

(30) Foreign Application Priority Data
Dec. 10, 2010 (KR) 10-2010-0126192

(51) Int. Cl. G05D 1/02

(52) U.S. Cl. 701/2

(57) ABSTRACT

Navigation of a robot is controlled using an electromyography sensor and an acceleration sensor by (a) comparing a signal from an electromyography sensor mounted to a human body with a prestored threshold value to determine whether to control the robot, (b) if the robot is to be controlled, comparing a signal obtained from an acceleration sensor mounted to the human body with each prestored reference model of an acceleration sensor signal to infer a control operation of the robot, and (c) controlling navigation of the robot to correspond to the inferred control operation of the robot. It is first determined whether to control the robot using the electromyography sensor signal, inferred by calculating a Euclidean distance between a current acceleration sensor signal and a reference model previously acquired for each operation, and the robot is controlled based on the inferred operation, thereby increasing accuracy and reliability of the robot control.

### CROSS-REFERENCE TO RELATED APPLICATION

This application claims priority to and the benefit of Korean Patent Application No. 2010-0126192, filed on Dec. 10, 2010, the disclosure of which is incorporated herein by reference in its entirety.

### BACKGROUND

1. Field of the Invention

The present invention relates to a method of controlling navigation of a robot using an electromyography sensor and an acceleration sensor and an apparatus therefor, and more particularly, to a method that enables a user to remotely control navigation of a robot using signals of an electromyography sensor and an acceleration sensor attached to a human body and an apparatus therefor.

2. Discussion of Related Art

Intelligent robots refer to robots that recognize an external environment and autonomically operate or interact with humans through self-judgment, unlike traditionally used industrial robots. Recently, intelligent robots have become increasingly involved in human's lives and are expected to occupy a large part of future industries. Accordingly, studies on intelligent robot give weight to interaction between humans and robots and improvement of intelligence of robots, and applications to several fields such as housework assistance, medical treatment and guides have been studied.

Robots include wheel-based robots, caterpillar-based robots, 2-legged robots, and multi-legged robots. A wheel-based robot has excellent performance in a flat place, but is incapable of stable navigation in a bumpy unstable environment. A caterpillar-based robot is capable of stable navigation even in such a bumpy environment, but navigates at a low speed and with low efficiency. Two-legged human type robots have been studied for decades in Japan, but do not provide satisfactory stability and practicality.

A conventional robot control method includes a method of controlling a robot using a dedicated device such as a joystick, a joypad, a mouse, or a keyboard or controlling navigation of a robot in response to a command from a user through voice recognition using a microphone or image recognition using a camera.

However, in such a conventional scheme, a separate dedicated apparatus must be used or performance is degraded due to effects of ambient environment. In particular, when voice is used, high ambient noise may cause malfunction. In the case of the image recognition using a camera, performance is greatly affected by brightness of light.

### SUMMARY OF THE INVENTION

The present invention is directed to a method of controlling navigation of a robot using an electromyography sensor and an acceleration sensor, which enables a user to remotely control navigation of the robot using signals of the electromyography sensor and the acceleration sensor mounted to a human body, and an apparatus therefor.

According to an aspect of the present invention, there is provided a method of controlling navigation of a robot, the method comprising: (a) comparing a signal obtained from an electromyography sensor mounted to a human body with a previously stored threshold value to determine whether the robot is to be controlled; (b) if it is determined that the robot is to be controlled, comparing a signal obtained from an acceleration sensor mounted to the human body with each previously stored reference model of an acceleration sensor signal to infer a control operation of the robot; and (c) controlling navigation of the robot to correspond to the inferred control operation of the robot.

According to another aspect of the present invention, there is provided an apparatus for controlling navigation of a robot, the apparatus comprising: a judgment unit for comparing a signal obtained from an electromyography sensor mounted to a human body with a previously stored threshold value to determine whether the robot is to be controlled; an inference unit for comparing a signal obtained from an acceleration sensor mounted to the human body with each previously stored reference model of an acceleration sensor signal to infer a control operation of the robot if it is determined that the robot is to be controlled; and a control unit for controlling navigation of the robot to correspond to the inferred control operation of the robot.

With the method of controlling navigation of a robot using an electromyography sensor and an acceleration sensor and an apparatus therefor according to the present invention, a user can remotely easily control the navigation of the robot using signals of the electromyography sensor and the acceleration sensor mounted to the human body.

Further, with the method of controlling navigation of a robot using an electromyography sensor and an acceleration sensor and the apparatus therefor according to the present invention, a determination is first made as to whether the robot is to be controlled using the signal of the electromyography sensor, the most similar operation is inferred by calculating a Euclidean distance between the signal of the acceleration sensor and a reference model previously acquired for each operation, and the robot control is performed based on the inferred operation, thereby increasing accuracy and reliability of the robot control.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows an example in which an electromyography sensor and an acceleration sensor according to the present invention are mounted;

FIG. 2 shows an example of a robot used in an embodiment of the present invention;

FIG. 3 is a flowchart showing a method of controlling navigation of a robot using an electromyography sensor and an acceleration sensor according to the present invention;

FIG. 4 is a block diagram showing a robot navigation control apparatus using an electromyography sensor and an acceleration sensor according to the present invention;

FIG. 5 shows an example of a control operation used in an embodiment of the present invention,

FIG. 6 shows a change of an output value of a triaxial acceleration sensor for each control operation according to an embodiment of the present invention; and

FIG. 7 shows an output distribution of an operation-specific acceleration sensor according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

The present invention relates to a method of controlling navigation of a robot using an electromyography sensor and an acceleration sensor and an apparatus therefor. A determination is made as to whether the robot is to be controlled using an electromyography sensor, an operation is inferred using a signal from an acceleration sensor, and then a forward movement, a backward movement, a left turn or a right turn of the robot can be controlled to correspond to the inferred operation.

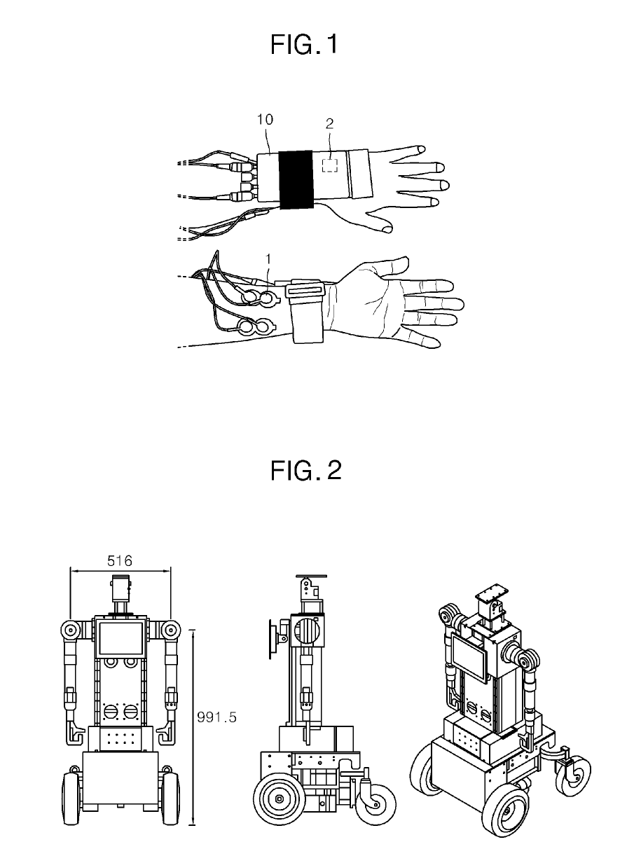

FIG. 1 illustrates an example in which an electromyography sensor and an acceleration sensor are mounted according to an embodiment of the present invention. The electromyography sensor 1 and the acceleration sensor 2 are mounted to a human body. In the present embodiment, an example in which the electromyography sensor 1 and the acceleration sensor 2 are mounted to a wrist will be described. A sensor module 10 is a Bluetooth-based electromyography and acceleration measurement module and is mounted to the wrist. The electromyography sensor 1 is connected to the sensor module 10. The electromyography sensor 1 includes a plurality of channels. In the present embodiment, only two channels are used. The electromyography sensor 1 is mounted to the wrist, more specifically, an inward portion of the arm adjacent to the wrist. The acceleration sensor 2 may be embedded in the sensor module 10 mounted to the wrist. In the present embodiment, the electromyography sensor 1 and the acceleration sensor 2 are mounted to the wrist, but the present invention is not necessarily limited thereto.

FIG. 2 illustrates an example of a robot used in an embodiment of the present invention. In the present embodiment, a method of controlling navigation of a wheel-based humanoid robot is provided. The humanoid robot includes an upper body imitating a function of a human body and a lower body configured of a wheel-based mobile chassis module. While, in a conventional technique, the robot is designed such that navigation of the chassis is controlled using an external joystick, navigation of the robot chassis in the present embodiment is controlled using a more intuitive and familiar method (e.g., a driving operation using a handle as in an automobile). It is to be understood that a robot applied to the present invention is not limited to the robot shown in FIG. 2.

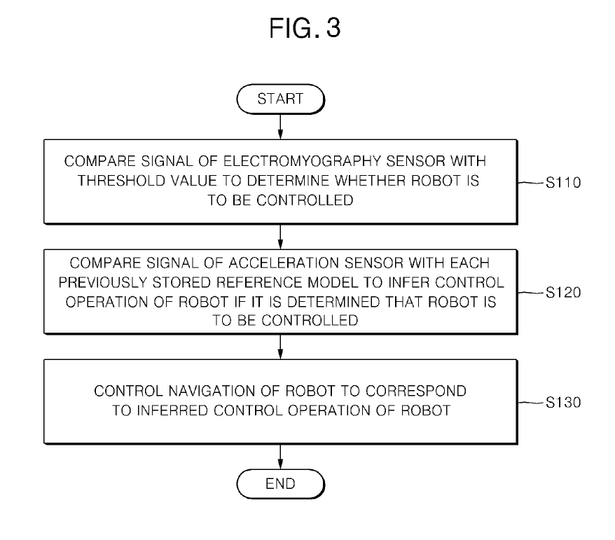

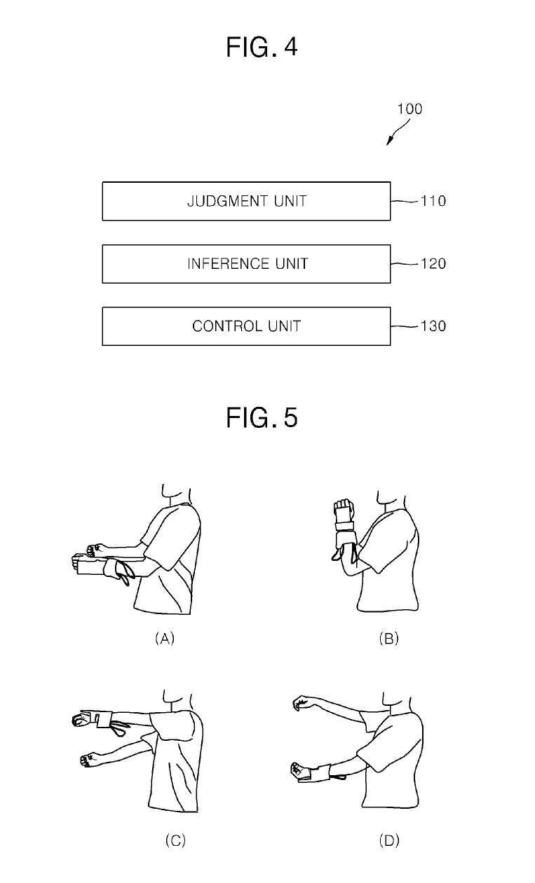

FIG. 3 is a flowchart showing a method of controlling navigation of a robot using an electromyography sensor and an acceleration sensor according to an embodiment of the present invention. FIG. 4 shows a configuration of an apparatus for implementing the method in FIG. 3. The apparatus 100 includes a judgment unit 110, an inference unit 120, and a control unit 130.

Hereinafter, the method of controlling navigation of a robot using an electromyography sensor and an acceleration sensor will be described in detail with reference to FIGS. 3 and 4.

First, the judgment unit 110 compares a signal obtained from the electromyography sensor 1 with a previously stored threshold value to determine whether the robot is to be controlled (S110).

If it is judged in step S110 that the signal obtained from the electromyography sensor 1 exceeds the threshold value, it is determined that the robot is to be controlled. If the signal obtained from the electromyography sensor 1 is less than the threshold value, the robot is not controlled but remains in a standby state. This means that power of an electromyography signal input every time is calculated, and if the calculated power exceeds the threshold value, the process proceeds to a next robot control step, and otherwise, the robot control is not performed.

In the present embodiment, a 2-channel electromyography sensor using the electromyography sensor 1 having two channels is used. In this case, an average power P of Q sampling signals generated from the two electromyography sensors 1 is processed as the signal obtained from the electromyography sensor and represented by Equation 1.

$$P = \frac{1}{2} {\sum }_{C = 1}^{2} [ \frac{1}{Q} {\sum }_{n = 1}^{Q} {\{ {r}_{C} [ n ] \}}^{2} ] \qquad [ Equatio n 1 ]$$

Here, C denotes the number of channels. In the present embodiment, since the electromyography sensor 1 having two channels is used, C has a value of 1 or 2, which is represented as Cε{1,2}. R_{c}[n] denotes a signal generated in a cε{1,2}-th channel, and n denotes a discrete time index sampled at 64 Hz. According to Equation 1, if the value of the average power P of the Q samples generated using the two electromyography sensor 1 channels exceeds a previously determined threshold value, the robot is controlled.

Next, the intention of robot navigation and direction control is recognized through signal processing for the acceleration sensor 2. That is, when it is determined in step S110 that the robot is to be controlled, the inference unit 120 compares a signal obtained from the acceleration sensor 2 with each previously stored reference model of an acceleration sensor signal to infer a control operation of the robot (S120).

More specifically, the signal obtained from the acceleration sensor signal is compared with each previously stored reference model of the acceleration sensor signal to infer the control operation of the robot as any one of a forward movement, a backward movement, a left turn, and a right turn. That is, each previously stored reference model is a reference model corresponding to a forward movement, a backward movement, a left turn, or a right turn of the robot. Step S120 will be described in greater detail.

FIG. 5 illustrates an example of control operations used in an embodiment of the present invention. Postures of the arm used for control include a total of four postures including a forward movement F, a backward movement B, a left turn L, and a right turn R in order of A, B, C, and D in FIG. 5. The forward movement is indicated by stretching the arm forward, the backward movement is indicated by folding the arm inward, and the left turn and the right turn are indicated by taking postures of a left turn and a right turn as when driving an automobile.

Prior to inference of the operation, reference models for the operation inference are first created. When respective operations Kε{F, B, L, R} are performed, an x-axis signal obtained from the triaxial acceleration sensor 2 is gₓ^{K}, a y-axis signal is g_{y}^{K}, and a z-axis signal is g_{z}^{K}. Here, the signal obtained from the triaxial acceleration sensor 2 is represented by g̅^̅{̅K̅}̅= [symbol] gₓ^{K}; g_{y}^{K}; g_{z}^{K} [symbol] using a vector, for convenience of illustration.

The operation-specific reference model used for final identification is acquired by obtaining operation-specific accelerations through repetitions of each operation and obtaining an average value of the operation-specific accelerations, for stabilization of the model.

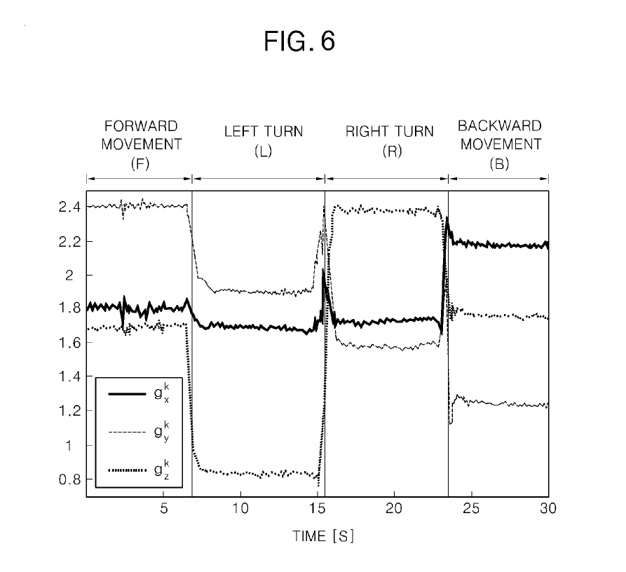

FIG. 6 illustrates a change of an output value of the triaxial acceleration sensor for each control operation according to an embodiment of the present invention. A horizontal axis indicates time and a vertical axis denotes an output voltage generated from the acceleration sensor 2. That is, it can be seen that output voltages for four control operations have different patterns.

The reference model of the operation-specific acceleration signal obtained through W repetitions is represented by Equation 2.

$$\overline{{m}^{K}} = 〈 {m}_{x}^{K} , {m}_{y}^{K} , {m}_{z}^{K} 〉 , \\ ( \begin{matrix}{m}_{x}^{K} = \frac{1}{w} {\sum }_{i = 1}^{w} {g}_{x}^{K} ( i ) , {m}_{y}^{K} = \frac{1}{w} {\sum }_{i = 1}^{w} {g}_{y}^{K} ( i ) , \\ {m}_{z}^{K} = \frac{1}{w} {\sum }_{i = 1}^{w} {g}_{z}^{K} ( i )\end{matrix} ) \qquad [ Equation 2 ]$$

When a robot is actually controlled, a signal generated every moment from the acceleration sensor 2 may be defined by Equation 3.

ā[n]=<a₁[n],a₂[n],a₃[n]> [Equation 3]

In this case, an inferred operation \hat{K} is identified as an operation having a minimum Euclidean distance between the acceleration value generated every moment and an acceleration value of the operation-specific reference model, and an identifying process may be represented by Equation 4. [Equation 4]

\hat{K}[n]=arg_{K}min∥ m̅^̅{̅K̅}̅− a̅[̅n̅]̅∥.

That is, in step S120, the acceleration value obtained from the acceleration sensor, that is, Equation 3, and the acceleration value of each reference model, that is, Equation 2, are compared with each other using Equation 4 to search for any one reference model having a minimum Euclidean distance, and an operation corresponding to the searched reference model is inferred as the current operation of the wrist.

After the control operation of the robots is inferred as described above, the control unit 130 controls the navigation of the robot to correspond to the inferred control operation of the robot (S130). In this case, control such as a forward movement, a backward movement, a left turn, and a right turn is realized by changing a wheel speed corresponding to the identifying result.

For movement speeds of left and right wheels according to individual operations, refer to Table 1.

TABLE 1

| | Left Wheel | | Right Wheel | |
|---|---|---|---|---|
| Forward (F) | 0.50 | m/s | 0.50 | m/s |
| Backward (B) | −0.50 | m/s | −0.50 | m/s |
| Left (L) | −0.25 | m/s | 0.25 | m/s |
| Right (R) | 0.25 | m/s | −0.25 | m/s |

Hereinafter, a result of an experiment in which an embodiment of the present invention was applied to robot control will be described. In order to confirm the accuracy of navigation and direction control for the robot for each control operation, 500 identifications were performed for each operation. The sample number Q used to calculate the value of the average power P was 16 and a threshold value of the average power was 15 μV². The number of repetitions ω performed for stabilization in creating the reference models was 100. For values of the operation-specific reference models obtained through the 100 repetitions, refer to Table 3.

TABLE 2

| | x axis | y axis | z axis |
|---|---|---|---|
| m̅^̅{̅F̅}̅ | 1.79 | 2.40 | 1.69 |
| m̅^̅{̅B̅}̅ | 1.69 | 1.90 | 0.83 |
| m̅^̅{̅L̅}̅ | 1.73 | 1.58 | 2.37 |
| m̅^̅{̅R̅}̅ | 2.17 | 1.24 | 1.75 |

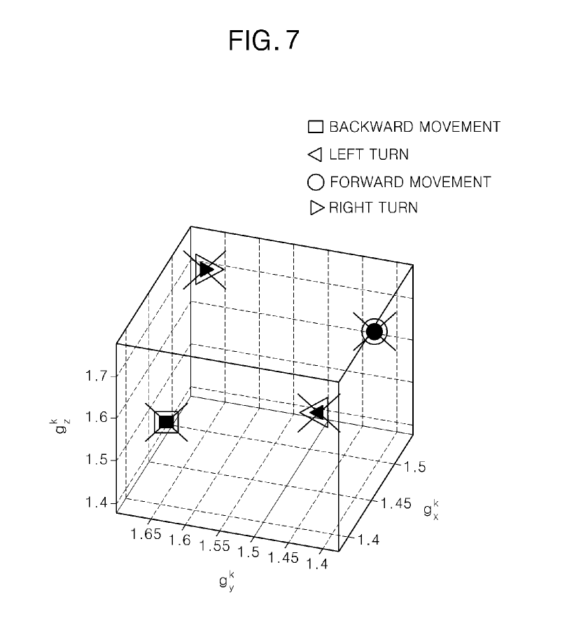

FIG. 7 illustrates an output distribution of an operation-specific acceleration sensor according to an embodiment of the present invention. It can be confirmed from FIG. 7 that distributions are well separated and do not overlap among the operations. Accuracy of the identification is shown in Table 3.

TABLE 3

| | Operation | | | |
|---|---|---|---|---|
| | Forward | Backward | Left | Right |
| Identification | Movement | movement | turn | turn |
| Forward (F) | 100% | 0.2% | 0% | 0% |
| Backward (B) | 0% | 99.8% | 0% | 0% |
| Left (L) | 0% | 0% | 100% | 0% |
| Right (R) | 0% | 0% | 0% | 100% |

It can be confirmed from Table 3 that all of four operations exhibited a success rate above 99% and the operation was stably identified.

As described above, in the present invention, a method of easily remotely controlling the robot using only a motion of user's arm can be embodied through the process of confirming the intention of navigation control of the robot using electromyography signal processing and the process of inferring a posture using acceleration signal processing, unlike a robot navigation control using an existing controller. In addition, it was confirmed that the method enables robot navigation control such as a forward movement, a backward movement, a left turn, and a right turn to be smoothly performed.

The determination as to whether the robot is to be controlled using the electromyography sensor was embodied using the average power of the 2-channel electromyography signal, and the reference models according to recognition of four operation-specific postures were used for the posture inference using the triaxial acceleration sensor. In the posture inference process, the most similar posture was inferred through the Euclidean distance between the acceleration vector value generated from the triaxial acceleration sensor and the acceleration vector value previously acquired for each operation, resulting in accuracy above 99%.

The present invention can be realized as a computer-readable code on a computer-readable recording medium. Computer-readable recording mediums include any type of recording device that stores computer system-readable data. Examples of the computer-readable recording medium include ROM, RAM, CD-ROM, magnetic tape, floppy disk, optical data storage, etc. The computer-readable recording mediums can also be realized in the form of a carrier wave (e.g., transmission through Internet). A computer-readable recording medium is distributed in computer systems connected via a wired or wireless network, and the computer-readable code can be stored and executed in a distributive scheme.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of controlling navigation of a robot, the method comprising:
(a) comparing a signal obtained from an electromyography sensor mounted to a human body with a previously stored threshold value to determine whether the robot is to be controlled;
(b) if it is determined that the robot is to be controlled, comparing a signal obtained from an acceleration sensor mounted to the human body with each previously stored reference model of an acceleration sensor signal to infer a control operation of the robot; and
(c) controlling navigation of the robot to correspond to the inferred control operation of the robot.

2. The method of claim 1, wherein step (a) comprises determining that the robot is to be controlled if the signal obtained from the electromyography sensor exceeds the threshold value.

3. The method of claim 2, wherein a plurality of electromyography sensors are provided, and an average power value of sampling signals generated from the plurality of electromyography sensors is processed as the signal obtained from the electromyography sensor.

4. The method of claim 1, wherein step (b) comprises comparing an acceleration value obtained from the acceleration sensor with an acceleration value of each reference model and inferring an operation corresponding to a reference model having a minimum Euclidean distance as the control operation of the robot.

5. The method of claim 4, wherein step (b) comprises comparing the signal obtained from the acceleration sensor with each previously stored reference model of the acceleration sensor signal to infer the control operation of the robot as any one of a forward movement, a backward movement, a left turn, and a right turn.

6. An apparatus for controlling navigation of a robot, the apparatus comprising:
a judgment unit for comparing a signal obtained from an electromyography sensor mounted to a human body with a previously stored threshold value to determine whether the robot is to be controlled;
an inference unit for comparing a signal obtained from an acceleration sensor mounted to the human body with each previously stored reference model of an acceleration sensor signal to infer a control operation of the robot if it is determined that the robot is to be controlled; and
a control unit for controlling navigation of the robot to correspond to the inferred control operation of the robot.

7. The apparatus of claim 6, wherein the judgment unit determines that the robot is to be controlled if the signal obtained from the electromyography sensor exceeds the threshold value.

8. The apparatus of claim 7, wherein a plurality of electromyography sensors are provided, and an average power value of sampling signals generated from the plurality of electromyography sensors is processed as the signal obtained from the electromyography sensor.

9. The apparatus of claim 6, wherein the inference unit compares an acceleration value obtained from the acceleration sensor with an acceleration value of each reference model and infers an operation corresponding to a reference model having a minimum Euclidean distance as the control operation of the robot.

10. The apparatus of claim 9, wherein the inference unit compares the signal obtained from the acceleration sensor with each previously stored reference model of the acceleration sensor signal to infer the control operation of the robot as any one of a forward movement, a backward movement, a left turn, and a right turn.
